(19) United States
(12) Patent Application Publication
(10) Pub. No.: US 2018/0319229 A1
(43) Pub. Date: Nov. 8, 2018

(54) Wheel Traction Assembly

(71) Applicant: Albaro Milan, Greeley, CO (US)

(72) Inventor: Albaro Milan, Greeley, CO (US)

(21) Appl. No.: 15/589,835

(22) Filed: May 8, 2017

(51) Int. Cl. B60C 27/04; B60C 27/02; B60C 27/20

(52) U.S. Cl. CPC B60C 27/04; B60C 27/20; B60C 27/0276

(57) ABSTRACT

A wheel traction assembly for enhancing traction of a vehicle that is stuck includes a pair of gripping units and the gripping units are movably coupled together. Each of the gripping units is selectively positioned on a tire of a vehicle when the vehicle is stuck. Moreover, each of the gripping units tapers to at least one point to frictionally engage the ground when the tire is rotated. In this way the gripping units enhance traction when the vehicle is stuck. A pair of retention units is provided and each of the retention units is coupled to the pair of gripping units. Each of the retention units is removably attached to the tire thereby retaining the pair of gripping units on the tire.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to traction devices and more particularly pertains to a new traction device for enhancing traction for a vehicle that is stuck.

### BRIEF SUMMARY OF THE INVENTION

An embodiment of the disclosure meets the needs presented above by generally comprising a pair of gripping units and the gripping units are movably coupled together. Each of the gripping units is selectively positioned on a tire of a vehicle when the vehicle is stuck. Moreover, each of the gripping units tapers to at least one point to frictionally engage the ground when the tire is rotated. In this way the gripping units enhance traction when the vehicle is stuck. A pair of retention units is provided and each of the retention units is coupled to the pair of gripping units. Each of the retention units is removably attached to the tire thereby retaining the pair of gripping units on the tire.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a wheel traction assembly according to an embodiment of the disclosure.

FIG. 2 is a right side view of an embodiment of the disclosure.

FIG. 3 is a bottom view of an embodiment of the disclosure.

FIG. 4 is a top view of an embodiment of the disclosure.

FIG. 5 is a perspective in-use view of an embodiment of the disclosure.

FIG. 6 is a perspective view of an alternative embodiment of the disclosure.

FIG. 7 is a right side view of an alternative embodiment of the disclosure.

### DETAILED DESCRIPTION OF THE INVENTION

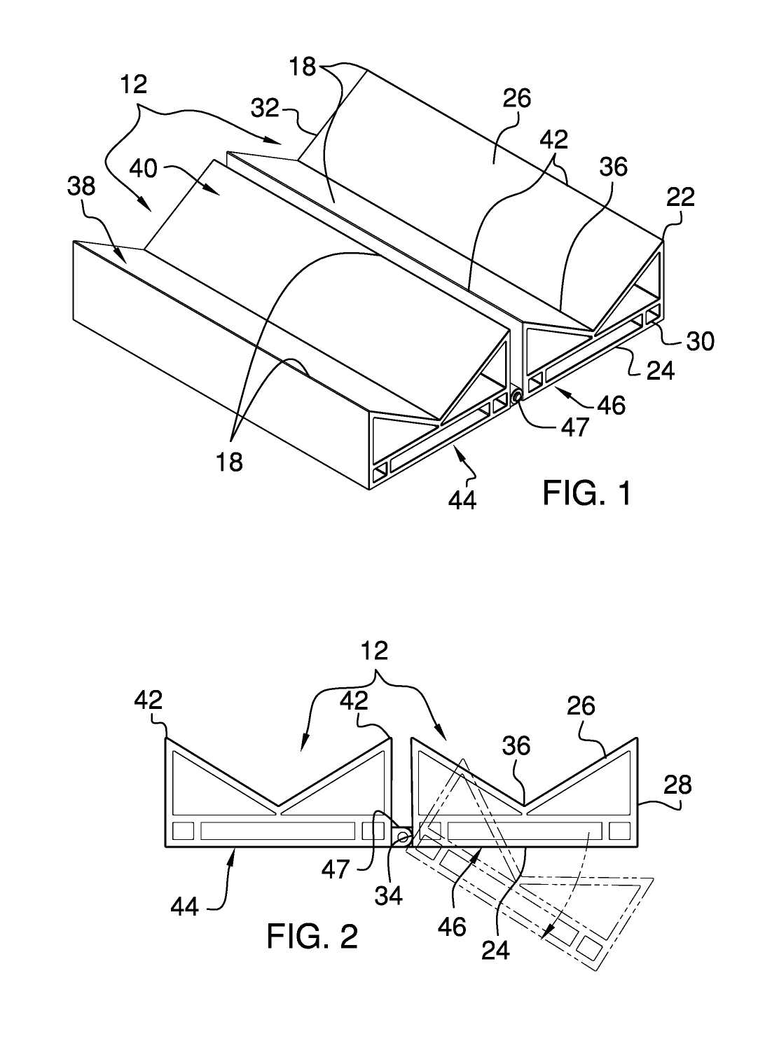

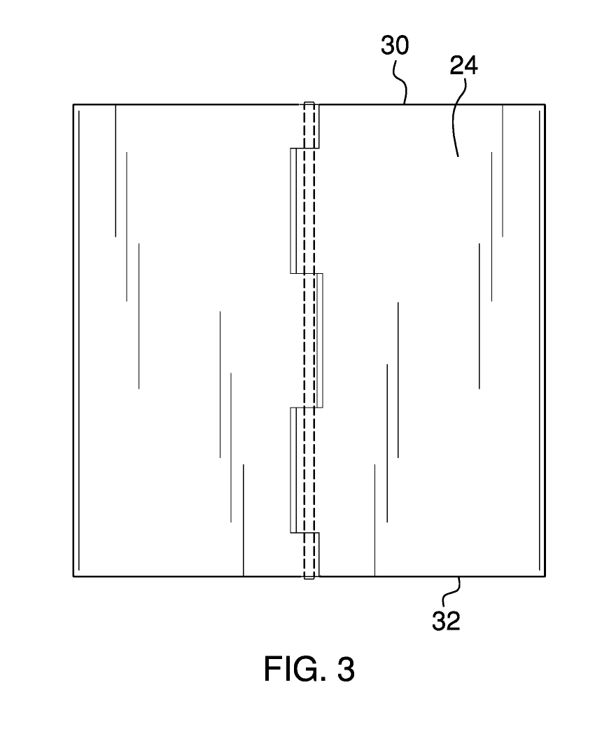

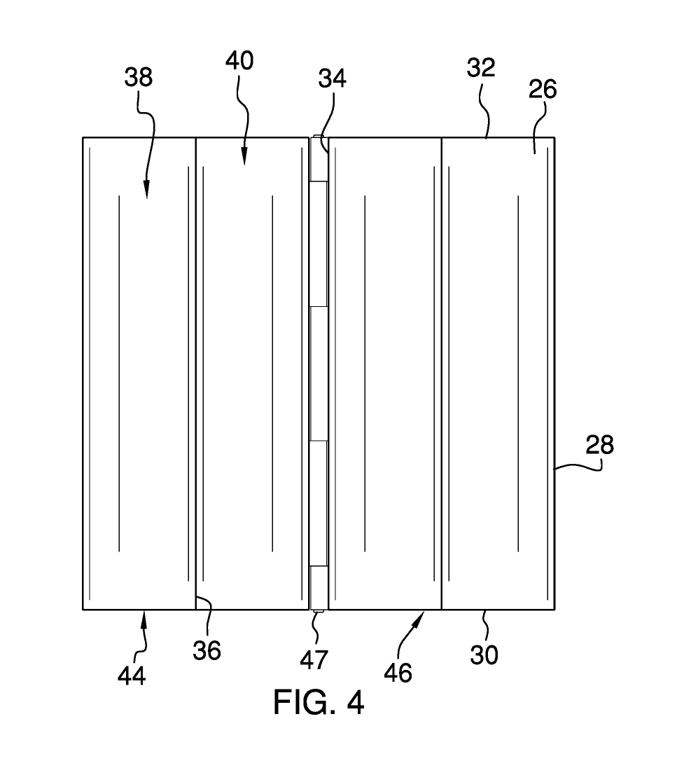

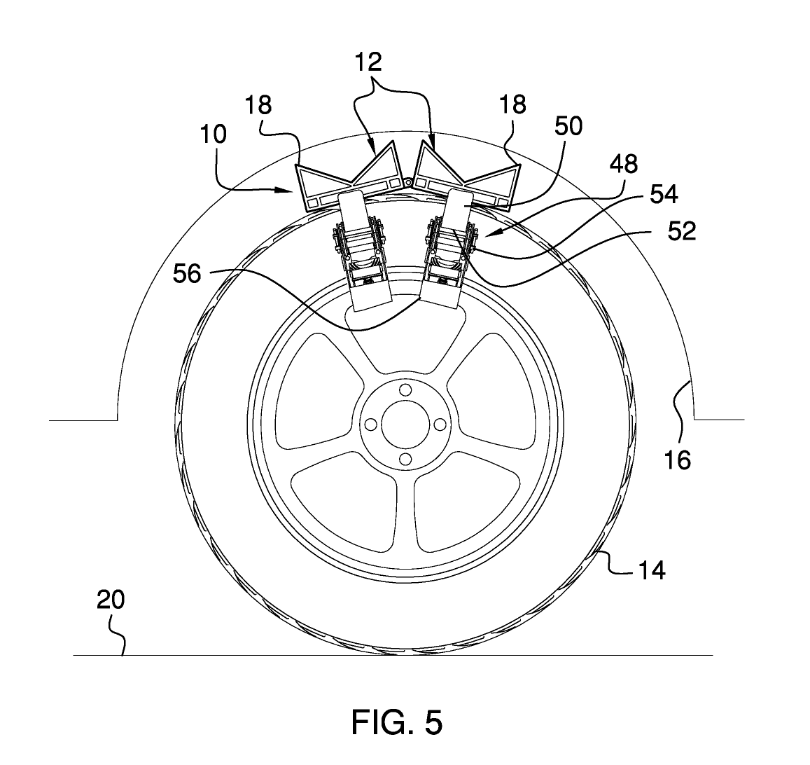

With reference now to the drawings, and in particular to FIGS. 1 through 7 thereof, a new traction device embodying the principles and concepts of an embodiment of the disclosure and generally designated by the reference numeral 10 will be described.

As best illustrated in FIGS. 1 through 7, the wheel traction assembly 10 generally comprises a pair of gripping units 12 that are each movably coupled together. Each of the gripping units 12 is selectively positioned on a tire 14 of a vehicle 16 when the vehicle 16 is stuck. The vehicle 16 may be a passenger vehicle, a cargo vehicle or any vehicle 16 that has tires. Additionally, the vehicle 16 may be stuck in snow, mud, ice or any other surface that provides minimal traction for the tire 14. Each of the gripping units 12 tapers to at least one point 18 to frictionally engage the ground 20 when the tire 14 is rotated. In this way the gripping units 12 enhance traction when the vehicle 16 is stuck.

Each of the pair of gripping units 12 comprises a block 22 that has a bottom wall 24, a top wall 26 and a perimeter wall 28 extending therebetween. The perimeter wall 28 has a first lateral side 30, a second lateral side 32 and a back side 34, and bottom wall 24 abuts the tire 14. The block 22 is elongated between the first lateral side 30 and the second lateral side 32 to extend across an entire width of the tire 14. The block 22 may be manufactured to be substantially hollow and the block 22 may be manufactured as solid structure.

The top wall 26 has a bend 36 therein extending between the first lateral side 30 and the second lateral side 32 to define a first half 38 of the top wall 26 forming an angle with a second half 40 of the top wall 26. Each of the first 38 and second 40 halves slopes downwardly toward the bottom wall 24 to define a pair of teeth 42. The pair of teeth 42 define the at least one point 18 and the pair of gripping units 12 includes a first gripping unit 44 and a second gripping unit 46.

A hinge 47 is coupled between the back side 34 corresponding to the first gripping unit 44 and the back side 34 corresponding to the second gripping unit 46. Thus, the first gripping unit 44 is hingedly coupled to the second gripping unit 46. In this way each of the first 44 and second 46 gripping units may follow a curve of the tire 14 when the first 44 and second 46 gripping units are positioned on the tire 14.

A pair of retention units 48 is provided and each of the retention units 48 is coupled to an associated one of the pair of gripping units 12. Each of the retention units 48 is removably attached to the tire 14 thereby retaining the pair of gripping units 12 on the tire 14. Each of the retention units 48 comprises a first strap 50 is coupled to the first lateral side 30 of the block 22 and the first strap 50 has a distal end 52 with respect to the block 22. The first strap 50 may be extended through the block 22 and the first strap 50 may be a unitary structure with respect to the block 22.

A mating unit 54 is coupled to the distal end 52 of the first strap 50 and the mating unit 54 is selectively manipulated. The mating unit 54 may comprise a cargo strap ratchet or the like. A second strap 56 is coupled to the second lateral side 32 of the block 22 and the second strap 56 is extended through a wheel 58 corresponding to the tire 14. The mating unit 54 engages the second strap 56 when the second strap 56 is extended through the wheel 58 to tighten the block 22 onto the tire 14.

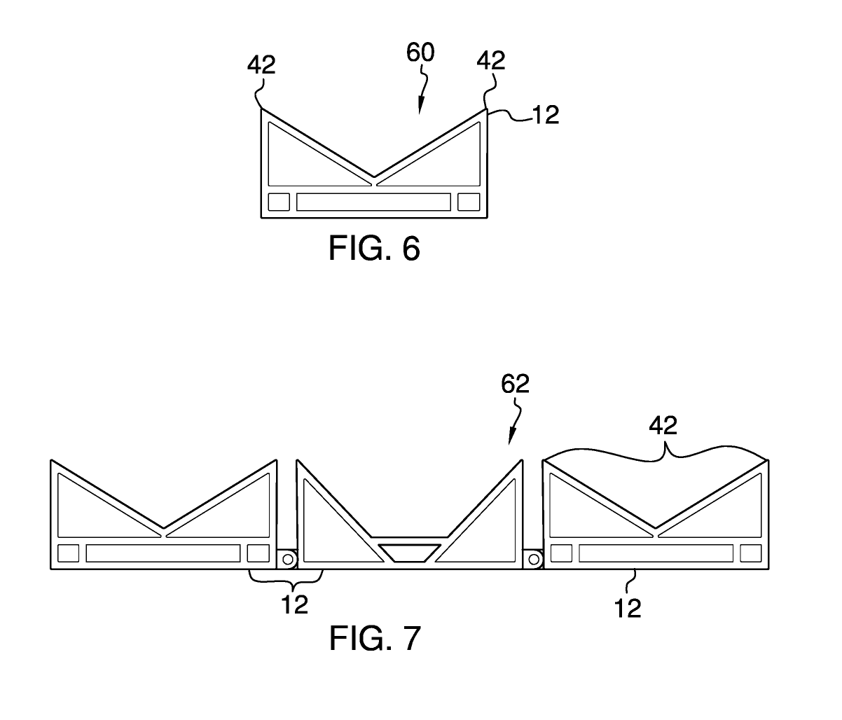

In an alternative embodiment 60 as shown in FIG. 6, a single one of the gripping units 12 may be provided. The single gripping unit 12 may be selectively positioned on the tire 14 of an ATV, a compact car or any other vehicle 16 that has smaller tires. In an alternative embodiment 62 as shown in FIG. 7, a plurality of the gripping units 12 may be provided and the plurality of gripping units 12 may be hingedly coupled together. The plurality of gripping units 12 may be selectively placed on the tire 14 of a semi truck, a full size pickup or any other vehicle 16 that has larger tires.

In use, the gripping units 12 are positioned on the tire 14 to extend laterally across the tire 14 when the vehicle 16 is stuck. The retention unit on each of the gripping units 12 is manipulated to retain each of the gripping units 12 on the tire 14. The teeth on each of the block 22s frictionally engage the ground 20 when the tire 14 is rotated. In this way traction is enhanced thereby facilitating the vehicle 16 to be unstuck. Each of the gripping units 12 is removed from the tire 14 when the vehicle 16 is no longer stuck.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wheel traction assembly being configured to be mounted on a tire for additional traction, said assembly comprising:
a pair of gripping units, each of said gripping units being movably coupled together, each of said gripping units being configured to be positioned on a tire of a vehicle when the vehicle is stuck, each of said gripping units tapering to at least one point wherein said at least one point is configured to frictionally engage the ground when the tire is rotated thereby enhancing traction when the vehicle is stuck; and
a pair of retention units, each of said retention units being coupled to said pair of gripping units wherein each of said retention units is configured to be removably attached to the tire thereby retaining said pair of gripping units on the tire.

2. The assembly according to claim 1, wherein each of said pair of gripping units comprises a block having a bottom wall, a top wall and a perimeter wall extending therebetween, said perimeter wall having a first lateral side, a second lateral side and a back side, bottom wall being configured to abut the tire, said block being elongated between said first lateral side and said second lateral side wherein said block is configured to extend across an entire width of the tire.

3. The assembly according to claim 2, wherein said top wall has a bend therein extending between said first lateral side and said second lateral side to define a first half of said top wall forming an angle with a second half of said top wall, each of said first and second halves sloping downwardly toward said bottom wall to define a pair of teeth wherein said pair of teeth is configured to frictionally engage the ground, said pair of gripping units including a first gripping unit and a second gripping unit.

4. The assembly according to claim 3, further comprising a hinge being coupled between said back side corresponding to said first gripping unit and said back side corresponding to said second gripping unit such that said first gripping unit is hingedly coupled to said second gripping unit wherein each of said first and second gripping units is configured to follow a curve of the tire.

5. The assembly according to claim 2, wherein each of said retention units comprises a first strap being coupled to said first lateral side of said block, said first strap having a distal end with respect to said block.

6. The assembly according to claim 5, further comprising a mating unit being coupled to said distal end of said first strap wherein said mating unit is configured to be manipulated.

7. The assembly according to claim 6, further comprising a second strap being coupled to said second lateral side of said block, said second strap being configured to be extended through a wheel corresponding to the tire, said mating unit engaging said second strap when the second strap is extended through the wheel wherein said mating unit is configured to tighten the block onto the tire.

8. A wheel traction assembly being configured to be mounted on a tire for additional traction, said assembly comprising:
a pair of gripping units, each of said gripping units being movably coupled together, each of said gripping units being configured to be positioned on a tire of a vehicle when the vehicle is stuck, each of said gripping units tapering to at least one point wherein said at least one point is configured to frictionally engage the ground when the tire is rotated thereby enhancing traction when the vehicle is stuck, each of said pair of gripping units comprising:
a block having a bottom wall, a top wall and a perimeter wall extending therebetween, said perimeter wall having a first lateral side, a second lateral side and a back side, bottom wall being configured to abut the tire, said block being elongated between said first lateral side and said second lateral side wherein said block is configured to extend across an entire width of the tire, said top wall having a bend therein extending between said first lateral side and said second lateral side to define a first half of said top wall forming an angle with a second half of said top wall, each of said first and second halves sloping downwardly toward said bottom wall to define a pair of teeth wherein said pair of teeth is configured to frictionally engage the ground, said pair of gripping units including a first gripping unit and a second gripping unit, and
a hinge being coupled between said back side corresponding to said first gripping unit and said back side corresponding to said second gripping unit such that said first gripping unit is hingedly coupled to said second gripping unit wherein each of said first and second gripping units is configured to follow a curve of the tire; and
a pair of retention units, each of said retention units being coupled to said pair of gripping units wherein each of said retention units is configured to be removably attached to the tire thereby retaining said pair of gripping units on the tire, each of said retention units comprising:
a first strap being coupled to said first lateral side of said block, said first strap having a distal end with respect to said block,
a mating unit being coupled to said distal end of said first strap wherein said mating unit is configured to be manipulated, and
a second strap being coupled to said second lateral side of said block, said second strap being configured to be extended through a wheel corresponding to the tire, said mating unit engaging said second strap when the second strap is extended through the wheel wherein said mating unit is configured to tighten the block onto the tire.
